(19) United States
(12) Patent Application Publication
(10) Pub. No.: US 2021/0281802 A1
(43) Pub. Date: Sep. 9, 2021

(54) IMPROVED METHOD AND SYSTEM FOR VIDEO CONFERENCES WITH HMDs

(71) Applicant: VESTEL ELEKTRONIK SANAYI VE TICARET A.S., Manisa (TR)

(72) Inventor: Barbaros KIRISKEN, Manisa (TR)

(21) Appl. No.: 16/334,432

(22) PCT Filed: Feb. 3, 2017
(86) PCT No.: PCT/EP2017/052449

§ 371 Date: Mar. 19, 2019

(51) Int. Cl. H04N 7/15; H04N 7/14; G02B 27/01; G02B 27/00

(52) U.S. Cl. CPC H04N 7/15; H04N 7/142; H04N 7/147; G02B 27/0093; G02B 27/017

(57) ABSTRACT

The present invention refers to a method for modifying video data during a video conference session. This method comprises at least the steps: Providing a first terminal (100A), comprising a first camera unit (103X) for capturing of at least visual input and a first head-mounted display (102); Providing a second terminal (100B) at least for outputting visual input, Providing or capturing first basic image data or first basic video data of a head of a first person (101) with the first camera unit (103X), Capturing first process image data or first process video data of the head of said first person (101) with the first camera unit while said first person (101) wears the head-mounted display (102), Determining first process data sections of the first process image data or first process video data representing the visual appearance of the first head-mounted display (102), Generating a first set of modified image data or modified video data by replacing the first process data sections of the first process image data or first process video data by first basic data sections, wherein the first basic data sections are part of the first basic image data or first basic video data and are representing parts of the face of said person, in particularly the eyes of said first person (101).

The present invention refers to a method for modifying video data during a video conference session according to claim 1, a computer program product for executing such a method according to claim 14 and a system for video conference sessions according to claim 15.

### BACKGROUND OF THE INVENTION

The technical field of the present invention refers to video conference systems. Such video conference systems enable visual communication via separated terminals, like computer or laptops or smartphones, over a data connection, in particular an internet connection. In some video conference systems head-mounted displays (HMDs) are used. Such HMD enable a virtual reality (VR) and/or augmented reality (AR) and/or mixed reality (MR).

Other than video conference, virtual meeting rooms, virtual spaces, role playing games and virtual environments in general are also carried out with HMDs and HMDs are annoying and disturbing in such applications as well if users real face cannot be seen.

Document U.S. Pat. No. 6,806,898B1 discloses a system and method for automatically adjusting gaze and head pose in a videoconferencing environment, where each participant has a camera and display. The images of participants are rendered in a virtual 3D space. Head-pose orientation and eye-gaze direction are corrected so that a participant's image in the 3D space appears to appear to be looking at the person they are looking at on the screen. If a participant is looking at the viewer, their gaze is set toward the “camera”, which gives the perception of eye-contact.

Document US20080252637 discloses a virtual reality-based teleconferencing.

Document US20110202306 discloses an adjustable virtual reality system.

Video-conference with head-mounted-displays can be disturbing, because the other people in the conference only see a small portion of the face of a person wearing said HMD—due to the large size of the HMD.

### Object of the Invention

Thus, it is the object of the present invention to provide a method for video conferences and a video conference system that improves user comfort during a video conference session.

### DESCRIPTION OF THE INVENTION

The before mentioned object is solved by a method for modifying video data during a video conference session according to claim 1. The inventive method comprises at least the steps: providing a first terminal, comprising a first camera unit for capturing of at least visual input and a first head-mounted display, providing a second terminal at least for outputting visual input, providing a server means or communication means or transfer medium, wherein said first terminal and said second terminal are connected via the transfer medium, in particular server means, for data exchange, providing or capturing first basic image data or first basic video data of a head of a first person with the first camera unit, capturing first process image data or first process video data of the head of said first person while said first person wears the head-mounted display with the first camera unit, determining first process data sections of the first process image data or first process video data representing the visual appearance of the first head-mounted display, generating a first set of modified image data or modified video data by replacing the first process data sections of the first process image data or first process video data by first basic data sections, wherein the first basic data sections are part of the first basic image data or first basic video data and are representing parts of the face of said person, in particularly the eyes of said person, in particular for outputting the first modified image data or first modified video data, in particular representing a complete face of said person, via at least one further terminal, in particular at least the second terminal.

Thus, the present invention discloses a method to provide a preferably full face video-conference while one, two or multiple users wear head-mounted-displays (HMD) such as virtual reality glasses (VR) or augmented reality glasses (AR). In case where one, two or multiple parties using HMDNR/AR devices significant portion of user face, especially eyes, are covered with HMDNR/AR device so that other user are not able see full face and making video-conference somehow meaningless. With the novel method, one or multiple prior recorded face pose/s of a person respectively an user is overlaid (superimposed) on real-time video and transferred to remote destinations to establish video-conference with full face view without any obstacle.

Further preferred embodiment are subject-matter of dependent claims and/or the following specification parts.

According to a preferred embodiment of the present invention the second terminal comprises a second camera unit and a second head-mounted display. The invention is further characterized by steps like providing or capturing second basic image data or second basic video data of a head of a second person with the second camera unit, and capturing second process image data or second process video data of the head of said second person while said second person wears the second head-mounted display with the second camera unit and determining second process data sections of the second process image data or second process video data representing the visual appearance of the second head-mounted display and generating respectively forming a second set of modified image data or modified video data by replacing the second process data sections of the second process image data or second process video data by second basic data sections, wherein the second basic data sections are part of the second basic image data or second basic video data and are representing parts of the face of said second person, in particularly the eyes of said second person, in particular for outputting the second modified image data or second modified video data via the first terminal. This embodiment is beneficial since not just one or not just at least one HMD is integrated into the video conference method. Thus, two or at least two persons or user can use the inventive video conference method while wearing HMDs.

The first modified image data or first modified video data and/or the second modified image data or second modified video data is/are according to a further preferred embodiment of the present invention outputted via at least one further terminal connected to the server means. This embodiment is beneficial since not every terminal needs to have a HMD. Thus, persons or users wearing or not wearing a HMD can interact in the same manner, in particular the faces, in particular full facer or without HMD, of each user respectively person are displayed on the one, two or at least one or at least two or multiple terminals.

A terminal can be understood as every device having a screen or projecting a visual image on a surface or in space. Thus, terminals are preferably laptops, tablet PCs, desktop PC, smartphones, TVs, etc. It is further conceivable that terminal and HMD are one device.

A further terminal comprises according to a further preferred embodiment of the present invention a further camera unit and a further head-mounted display. The invention is further characterized by the steps providing or capturing further basic image data or further basic video data of a head of a further person with the further camera unit, capturing further process image data or further process video data of the head of said further person while said further person wears the further head-mounted display with the further camera unit, determining further process data sections of the further process image data or further process video data representing the visual appearance of the further head-mounted display, forming a further set of modified image data or modified video data by replacing the further process data sections of the further process image data or further process video data by further basic data sections, wherein the further basic data sections are part of the further basic image data or further basic video data and are representing parts of the face of said further person, in particularly the eyes of said further person, in particular outputting the further modified image data or further modified video data via the first terminal and/or via the second terminal and/or any further terminal, in particular at the same time. This embodiment is beneficial since multiple users or persons, in particular more than two or three or more than three or four or more than four can wear respectively use HMDs. It is also conceivable that different types of HMDs, in particular VR and AR devices, are utilized in the same video conference session. Thus, each HMD represented by process image data or process video data can be replaced with data representing a face part, in particular the eyes, of a user using said respective HMD.

First, second and/or further basic video data or first, second and/or further basic image data are according to a preferred embodiment of the present invention stored in a memory of the respective terminal and/or on the server means. First, second and/or further basic video data or first, second and/or further basic image data are captured once and processed in case first, second and/or further modified video data or first, second and/or further modified image data is required. Alternatively first, second and/or further basic video data or first, second and/or further basic image data are captured each time said first, second and/or third person joins a video conference and the first, second and/or further basic video data or first, second and/or further basic image data is updated or replaced and processed in case first, second and/or further modified video data or first, second and/or further modified image data is required.

At least one terminal and preferably the majority of terminals or all terminals are according to a further preferred embodiment of the present invention comprising means for capturing and/or outputting audio data, wherein said captured audio data captured by one terminal is at least routed to one or multiple further terminals. Such a means can be e.g. a microphone. The audio capturing means can be arranged at the HMD or can be part of the terminal.

The position of the first head-mounted display with respect to the face of the first person is determined according to a further preferred embodiment of the present invention by means of object recognition. The shape of the first head-mounted display is preferably determined by object recognition and/or identification data visually or electronically provided. Electronical identification data is provided due to a data connection between the first head-mounted display and the first terminal. The position of the second head-mounted display with respect to the face of the second person is determined according to a further preferred embodiment of the present invention by means of object recognition. The shape of the second head-mounted display is preferably determined by object recognition and/or identification data visually or electronically provided. Electronical identification data is provided due to a data connection between the second head-mounted display and the second terminal. The position of the further head-mounted display with respect to the face of the further person is determined according to a further preferred embodiment of the present invention by means of object recognition. The shape of the further head-mounted display is preferably determined by object recognition and/or identification data visually or electronically provided. Electronical identification data is provided due to a data connection between the further head-mounted display and the further terminal.

Face movement data representing movements of skin portions of the face of the first person is according to a further preferred embodiment of the present invention generated, wherein the movements of the skin portions are captured by said first camera unit. Face movement data representing movements of skin portions of the face of the second person is preferably also generated, wherein the movements of the skin portions are captured by said second camera unit. Face movement data representing movements of skin portions of the face of the third person is preferably also generated, wherein the movements of the skin portions are captured by said third camera unit.

Eye movement data representing movements of at least one eye of the first person is generated according to a further preferred embodiment of the present invention, wherein the movements of the eye are captured by an eye tracking means. Eye movement data representing movements of at least one eye of the second person is also generated, wherein the movements of the eye are captured by a second eye tracking means. Eye movement data representing movements of at least one eye of the further person is also generated, wherein the movements of the eye are captured by a further eye tracking means. Skin movements of the face can be detected by an optional face movement detector, wherein said face movement detector can be provided in addition or alternatively to an eye tracking means. It is further conceivable that a combined eye tracking and face movement detector is provided, in particular arranged on or inside the HMD or as part of the HMD.

First basic data sections are according to a further preferred embodiment modified in dependency of said captured face movement data of the face of the first person and/or of said captured eye movement data of at least one eye of the first person. Second basic data sections are according to a further preferred embodiment modified in dependency of said captured face movement data of the face of the second person and/or of said captured eye movement data of at least one eye of the second person. Third basic data sections are according to a further preferred embodiment modified in dependency of said captured face movement data of the face of the third person and/or of said captured eye movement data of at least one eye of the third person.

Eye data representing shapes of the eyes of the first person as part of the first basic data sections is identified according to a further preferred embodiment. The eye data is preferably modified in dependency of said captured eye movement data and/or skin data representing the skin portions of the face of the first person above and/or below the eyes in the first basic data section is preferably identified. The skin data is preferably modified in dependency of said captured face movement data. Eye data representing shapes of the eyes of the second person as part of the second basic data sections is identified according to a further preferred embodiment. The eye data is preferably modified in dependency of said captured eye movement data and/or skin data representing the skin portions of the face of the second person above and/or below the eyes in the second basic data section is preferably identified. The skin data is preferably modified in dependency of said captured face movement data. Eye data representing shapes of the eyes of the further person as part of the further basic data sections is identified according to a further preferred embodiment. The eye data is preferably modified in dependency of said captured eye movement data and/or skin data representing the skin portions of the face of the further person above and/or below the eyes in the further basic data section is preferably identified. The skin data is preferably modified in dependency of said captured face movement data. This embodiment is beneficial since visual data representing the eye movement of the respective person using a HMD can be utilized to further enhance the usability and/or comfort of a video conference session respectively system.

An eye tracking means is preferably a near eye PCCR tracker. Said eye tracking means is preferably arrange on or inside the first head-mounted display and/or on or inside the second head-mounted display and/or on or inside the further head-mounted display.

According to a further preferred embodiment of the present invention the inventive method comprises the steps of receiving information, in particular by means of camera unit, relating to the pose of the head of the first person, orienting a virtual model of the head and facial gaze of the head according to the pose of the object, in particular head of first person, projecting visible pixels from a portion of the videoconference communication onto the virtual model, creating synthesized eyes of the head that produces a facial gaze at a desired point in space, orienting the virtual model according to the produced facial gaze; and projecting the virtual model onto a corresponding portion of the videoconference communication, wherein at least one part of the first set of modified image data or modified video data is replaced by said virtual model. This embodiment is beneficial since the respective (first, second and/or further) process image data or (first, second and/or further) process video data can be modified to further enhance the inventive method respectively inventive system.

Creating synthesized eyes preferably includes receiving segmentation information of the eyes and estimating iris and pupil information to create the synthetic eye. Synthesized eyes further preferably include digitally drawing the synthetic eyes on a corresponding portion of the video conference communication using the segmentation information to replace the original eyes with the synthetic eyes. Preferably, a step of digitally adjusting the synthesized eyes of the virtual model in real time during videoconference communication is provided. The video conference communication preferably occurs between at least two participants and is highly preferably facilitated by at least one of the Internet, integrated services digital network, or a direct communication link.

The present invention further refers to a computer program product for executing a method according to claims 1-13.

The present invention further refers to a system for video conference sessions. Said system preferably comprises at least a first terminal, comprising a first camera unit for capturing of at least visual input and a first head-mounted display, a second terminal at least for outputting visual input, a server means, wherein said first terminal and said second terminal are connected via the server means for data exchange, wherein first basic image data or first basic video data of a head of a first person is provided or captured with the first camera unit, wherein first process image data or first process video data of the head of said first person is captured while said first person wears the head-mounted display with the first camera unit, wherein first process data sections of the first process image data or first process video data representing the visual appearance of the first head-mounted display is determined, wherein a first set of modified image data or modified video data is formed by replacing the first process data sections of the first process image data or first process video data by first basic data sections, wherein the first basic data sections are part of the first basic image data or first basic video data and are representing parts of the face of said person, in particularly the eyes of said person, wherein the first modified image data or first modified video data, in particular representing a complete face of said person, are outputted via the second terminal.

Further benefits, goals and features of the present invention will be described by the following specification of the attached figures, in which exemplarily components of the invention are illustrated. Components of the systems and methods according to the inventions, which match at least essentially with respect to their function can be marked with the same reference sign, wherein such components do not have to be marked or described multiple times with respect to said figures.

In the following the invention is just exemplarily described with respect to the attached figures.

### BRIEF DESCRIPTION OF THE DRAWING

FIG. 1 shows a schematic illustration of a state of the art video conference session in which HMDs are used;

FIG. 2 shows a first schematic illustration of a video conference session according to the present invention in which HMDs are also used;

FIG. 3 shows a second schematic illustration of a video conference session according to the present invention in which HMDs are also used;

FIG. 4 shows schematically a replacement of pixels representing a HMD by pixels representing a portion of a human face shape;

FIG. 5 shows several HMDs which can be used during the inventive video conference session;

FIG. 6 shows several possibilities for identifying the HMD in use respectively for detecting the shape of the HMD in use;

FIG. 7 shows a front and a side view of a schematically illustrated HMD, wherein the shown HMD comprises an eye tracking means;

FIG. 8 shows schematically a scene during facial motion tracking, wherein facial motion tracking can be performed with or without markers;

FIG. 9 shows an example of a system activation flow chart;

FIG. 10 shows schematically an example of a flow chart representing steps during image processing; and

FIG. 11 shows schematically a video conference with multiple users.

FIG. 12 shows multiple users connected to a virtual environment, virtual meeting room in exemplary case.

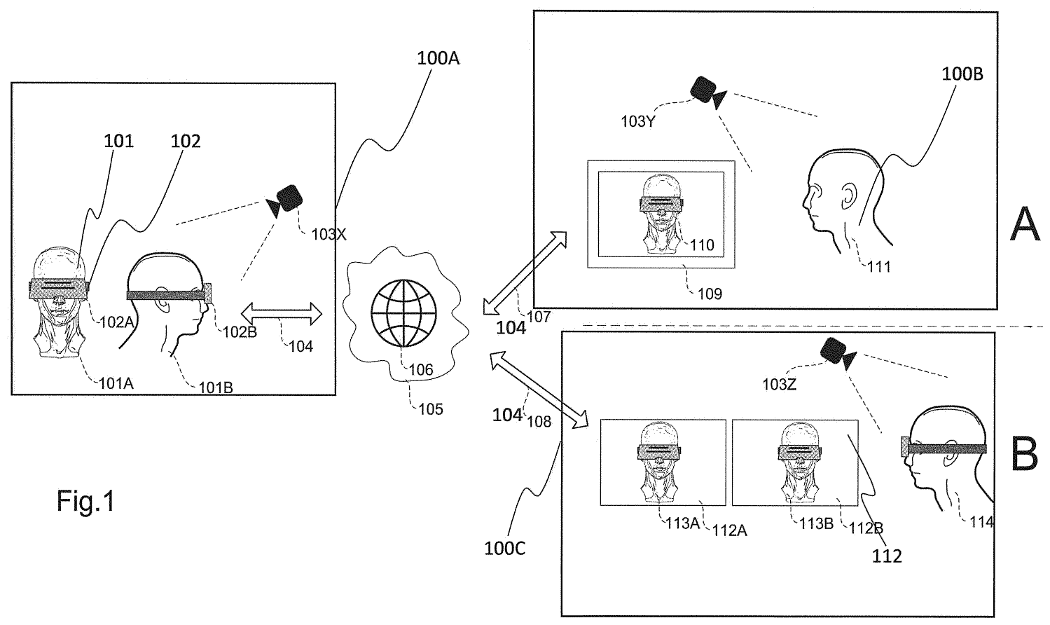

FIG. 1 shows a prior art setting. A front view 101A of a head of a first user and side view (profile) 101B of said head of the first user 101 are shown herein. The first user 101 wears a HMD 102. Said HMD 102 (VR glass in exemplary case) is shown in a front view 102A and in a side view 102B. The head of first user 101 is captured by a first camera unit 103X. The first camera unit 103X is a camera unit that can be utilized during video-conference sessions. The first camera unit 103X is preferably positioned externally in exemplary case but any other option is possible.

Reference number 103Y indicates a second camera unit. The head of a second user 111 is captured by said second camera unit 103Y. The second camera unit 103Y is a camera unit that can be utilized during video-conference sessions. The second camera unit 103Y is preferably positioned externally in exemplary case but any other option is possible. It is also conceivable that second user 111 uses or wears a HMD during an inventive video conference session.

Reference number 103Z indicates a further camera unit. The head of a further user 114 is captured by said further camera unit 103Z. The further camera unit 103Z is a camera unit that can be utilized during video-conference sessions. The further camera unit 103Z is preferably positioned externally in exemplary case but any other option is possible.

Reference number A indicates a case in which first user 101 and second user 111 are communicating via the video conferencing system. In this case only first user 101 wears a HMD, second user 111 utilizes an optical output means which is different from a HMD, like a screen. In this case data captured by first camera 103X and by second camera 103Y are transferred to the other party via any transfer medium 105 for video-conferences. The transfer medium 105 is preferably a server unit, in particular the Internet, in exemplary case. It is further possible to send audio data as well as video data via path 104 from a first user terminal 100A on the side of the first user 101 to a second user terminal 100B on the side of the second user 111 and vice versa. Thus, video data captured with the first camera unit 103X is outputted via screen 109 to the second user 111. Thus, the second user 111 sees the first user wearing a HMD 110.

Reference number B indicates a case in which first user 101 and further user 114 are communicating via the video conferencing system. In this case both first user 101 and further user 114 are using respectively wearing HMDs. In this case data captured by first camera 103X and by further camera 103Z are transferred to the other party via any transfer medium 105 for video-conferences. The transfer medium 105 is preferably a server unit, in particular the internet, in exemplary case. It is further possible to send audio data as well as video data via path 104 from a first user terminal 100A on the side of the first user 101 to a further user terminal 100C on the side of further user 114 and vice versa. Thus, video data captured with the first camera unit 103X is outputted via HMD 112 to the second user 111. Video data captured by first camera unit 103A is preferably outputted via right screen of HMD 112 and left screen of HMD 112. Thus, second user 111 sees the first user wearing a HMD 110, that means video of first user 101 is transferred 113A, 1138 without any alteration to right screen 112A of HMD 112 respectively glass and to left screen 112B of HMD respectively glass.

Thus, FIG. 1 simply describes what happened while invention turned-off also state of prior art, where there is no possible full face image transfer because user have HMD (VR glass in figure) no eye contact and no face-to-face communication, which highly annoys participants of video-conference.

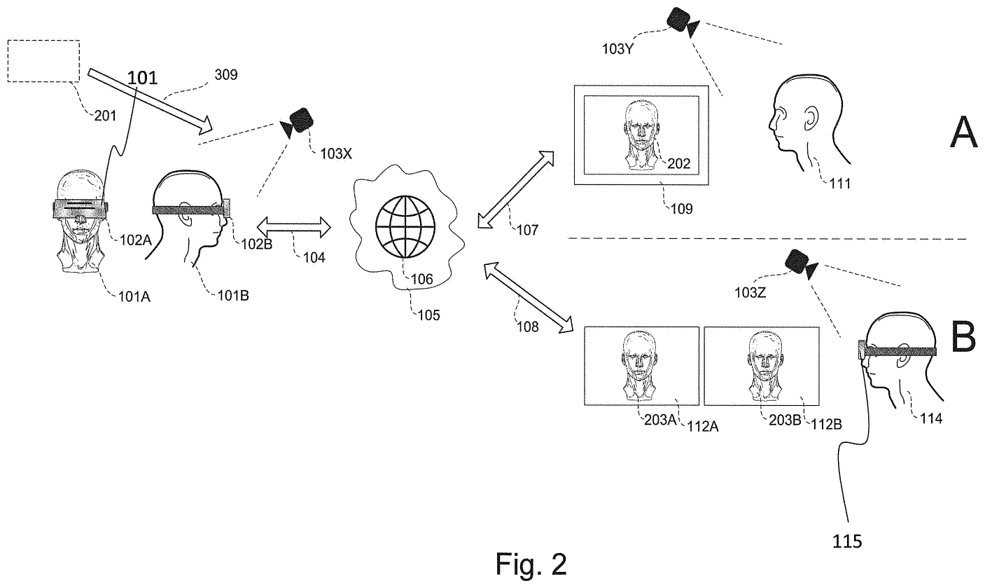

FIG. 2 shows a first schematically illustration of the inventive method and system. Reference number 201 indicates recorded head data of first user 101 for facial motion capturing, in particular captured with any method either vector, raster, image and/or video. Said recorded head data 201 preferably comprises no data representing a HMD, thus preferably just data representing the head, in particular the face, in particular the shape of face, in particular above mouth and below forehead, in particular the eyes region of a face. Said recorded head data 201 of first user 101 can be transferred to a computing system or unit, in particular a server and/or first terminal 100A or second terminal 100B or any further terminal 100C. Computing system or unit modifies data captured by first camera unit 103X with recorded data 201. Modifying hereby preferably means combining, replacing, overlaying respectively superimposing, in particular in real time. Thus, a video or picture is outputted to second user 111, wherein said video or picture is different from the video or picture captured by first camera unit 103X. The outputted respectively viewed picture is preferably artificially generated in particular by combining data captured by camera 103X and recorded head data 201. Thus, reference number 202 represents image data that transfers full face view of first user 101 even he or she uses HMD.

Also in case B further user 114 sees the eyes, in particular the full face of first person 101.

Thus, reference number 203A represents image data that transfers full face view of first user 101 even he or she uses HMD for right display of HMD, in particular VR glass. Thus, reference number 203B represents image data that transfers full face view of first user 101 even he or she uses HMD for right display of HMD, in particular VR glass.

Therefore, the present invention discloses a method for modifying video data during a video conference session or a method for providing an advanced video conference session. A first terminal 100A is provided and used, wherein first terminal 100A can be a laptop, desktop, mobile phone, tablet PC, TV or the like. Said terminal 100A preferably comprises a first camera unit 103X for capturing of at least visual input and further comprises a first head-mounted display 102. Furthermore, a second terminal 100B is provided and used at least for outputting visual input. Preferably a data transfer means, in particular a server means 106 is provided, wherein said first terminal 100A and said second terminal 100B are connected via server means 106 respectively data transfer means for data exchange. First basic image data or first basic video data 201 of a head of a first person 101 is preferably provided or captured with the first camera unit 103X. First process image data or first process video data of the head of said first person 101 while said first person 101 wears the first head-mounted display 102 is captured with first camera unit 103X. First process data sections of the first process image data or first process video data representing the visual appearance of the first head-mounted display 102 are captured, wherein a first set of modified image data or modified video data is generated by replacing the first process data sections of the first process image data or first process video data by first basic data sections. The first basic data sections are preferably part of the first basic image data or first basic video data and are representing parts of the face of said first person 101, in particularly the eyes of said person 101. The first modified image data or first modified video data, in particular representing a complete face of said first person 101, can be outputted respectively shown via an output device, in particular a screen, of the second terminal 100B.

Thus, the invention is related with video-conferencing (or any other tele-conferencing technique) while one or more users using respectively wearing HMD (Head-mounted-display). A HMD (Head-mounted-display) can be any virtual reality glasses either stand alone h its own display or mobile phone attachment, augmented reality glasses, which superimpose augmented images (videos) over real world, mixed reality devices and/or head-up-displays (HUD).

Camera devices respectively camera units 103X-103Z can be any camera, some examples external cameras or embedded camera of mobile phone or any computer. Camera can be single lens camera or dual lens (multiple lens) even light field camera.

Video-conference can be done over internet, with instant messenger (IM) or voip environment. Video-conference term preferably covers all kind of videoconferencing activities such as teleconference.

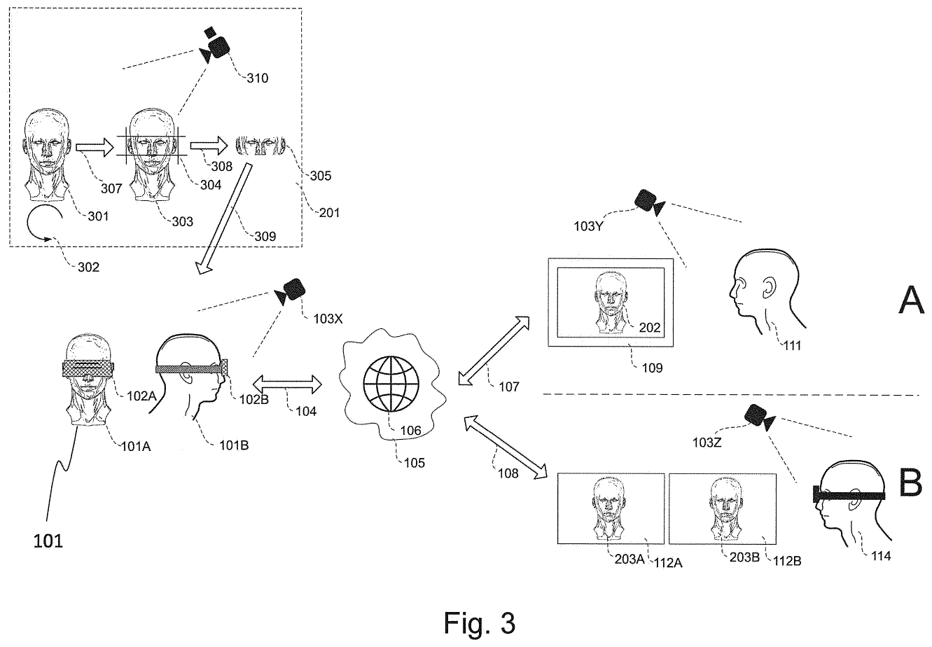

FIG. 3 shows how recorded head data 201 is captured and processed.

User head data 301 is either taken with learning cycle or recorded video or similar technique. Head data for the head of first user 101 is preferably captured of a front perspective of said head. Reference number 302 indicates a rotation movement of said head and/or of said camera unit 310, in particular in a range of at least 180° or of at least 270° or of 360°. Camera unit 310 is preferably a recording device, in particular a simple camera or more complex devices such as immersive or light depth camera preferably with scanning laser support. It is further conceivable that camera unit 310 is the first camera unit 103X or another camera unit. The size of first HMD 102 is detected and the user head data 301 is suitably cropped 307 for replacing the data representing the HMD of image or video data captured of first person 101 while using respectively wearing a HMD. The cropped data is transferred 308 to an unit for graphic respectively image data or video data modification.

Cropped data 305 is provided 309 for modifying image or video data captured by first camera unit 103X, in particular process image data or process video data.

Therefore, FIG. 2 and FIG. 3 demonstrate states while the invention is used and benefits of invention. Recorded face data (face pose) is cropped with the size of HMD and combined (overlay respectively superimpose) preferably with real time video and transferred video to second and further user are full face of first user as he/she is not using HMD which improves overall video-conference experience. In FIG. 2 and FIG. 3 computations related with image/video processing are done at first user side but any other option is possible, e.g. on a server or on a terminal 100A, 100B of the respective recipient. It is also conceivable that many, in particular more than two, users are joining the same video conference session, wherein multiple or all users are using or wearing a HMD. Therefore, image or video data (process image data or process video data) of preferably all users using a HMD are preferably modified with image or video data representing face surface parts, in particularly the eyes, of the respective user.

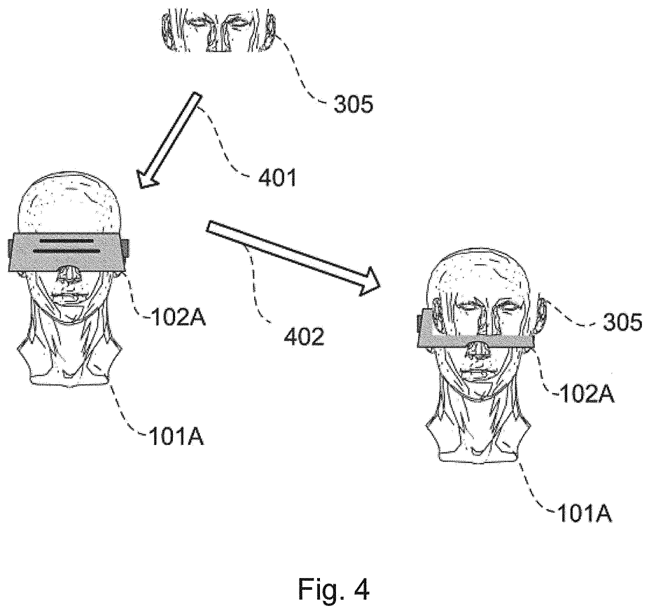

FIG. 4 shows an example for an overlay respectively replacing process. Cropped data 305 respectively data representing a predefined part of a face, in particular of the face of first user 101, in particular the eyes, overlays or replaces at least one part of process image data or process video data representing the HMD. In other words and as one option: cropped immersive data 305 is transferred 401 to process image data or process video data for partially or sectionally overlaying 402 said process image data or said process video data.

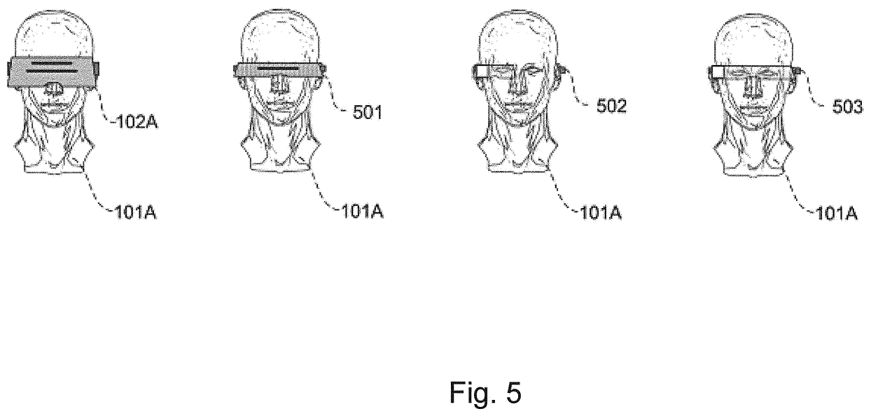

FIG. 5 shows four examples for HMD embodiments. Reference number 102A refers to a VR glass (with mobile phone/smart phone as screen), reference number 501 refers to a standalone VR glass or VR glass with own screen, reference number 502 refers to a kind of AR glass or mixed reality glass with one eye coverage and reference number 503 refers to a kind of AR glass or mixed reality glass with both eye coverage. Thus, FIG. 5 demonstrates different HMD's with different coverage area over the face with largest of VR glass with smart phone.

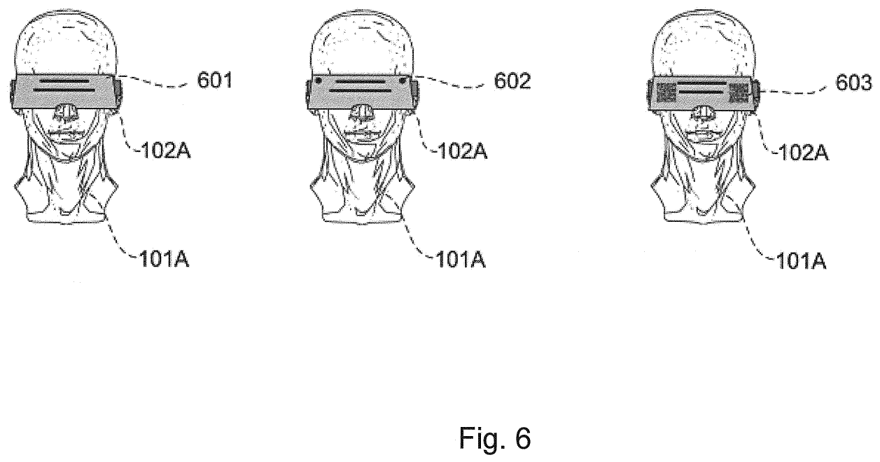

FIG. 6 shows three examples how information, in particular shape and/or coloring and/or size, about the HMD in use can be gathered. Reference number 601 refers to a marker-less detection or electronic detection for motion capture and size detection. Thus, the features of a HMD can be gathered by image analysis. Reference number 602 indicates special shapes or points or dot markers on the parts of the HMD which are visible for camera unit 103X. Reference number 603 indicates QR markers, wherein the QR-code represents information about the feature of HMD or a link for downloading data representing features of said HMD. Thus, FIG. 6 demonstrates how system detects user face position HMD position and maybe HMD size. For more immersive video-conference system need to position user eyes correctly where he/she looking and correct expression different sensors and eye tracking mechanisms can be used.

Further possibilities, like data transfer via wireless technology like NFC or Bluetooth or RFID or WiFi or non-wireless respectively cable connection technology, in particular USB, are additionally or alternatively conceivable.

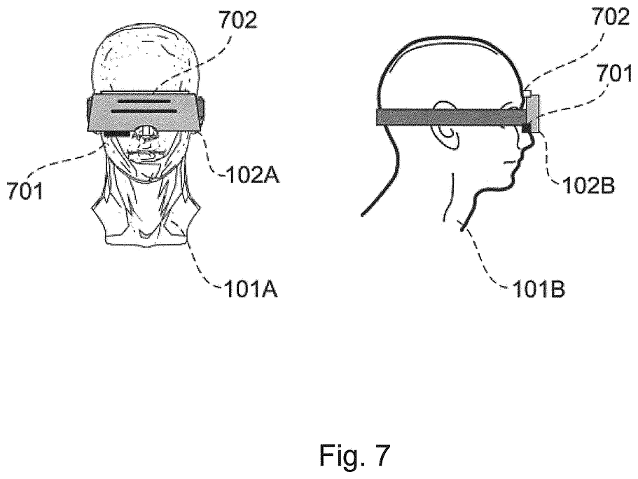

FIG. 7 shows a special HMD 102A. This HMD 102A preferably comprises an eye tracker, in particular of any kind (most probably near eye PCCR tracker), 701 and/or a detector for detecting face movements (either capacitive or optical) 702. The user head data 301, in particular the cropped user head data, is preferably modified in dependency of measurements measured by said eye tracker 701 and/or said face movement detector 702. Thus, the displayed appearance of the face of the first user 101 appears even more realistic.

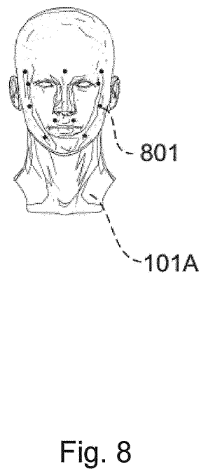

FIG. 8 shows an example for facial motion tracking. Optical detection of dot markers 801 allows a determination respectively analysis of facial motions. However, different detection methods such as marker-less methods are alternatively or additionally possible.

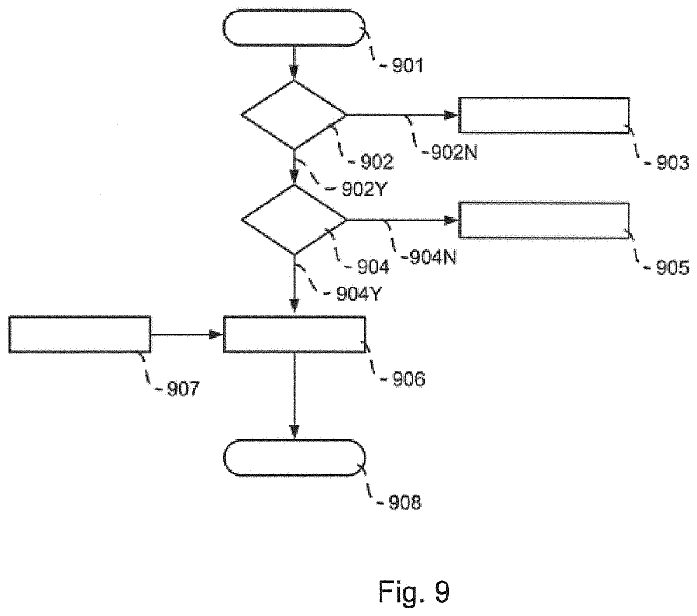

FIG. 9 shows a flow chart representing a system activation.

According to reference number 901 the inventive system respectively a video conference session is started. Thus, it is checked in 902 if the system is really started, in case system is not started 902N nothing happens 904. In case system is really started 902Y it is checked if at least one HMD is detected 904. In case no HMD device is detected 904N nothing happens. In case a HMD device is detected 904Y recorded data (basic image data or basic video data) is requested respectively loaded or generated. Then, initiation of system ends 908.

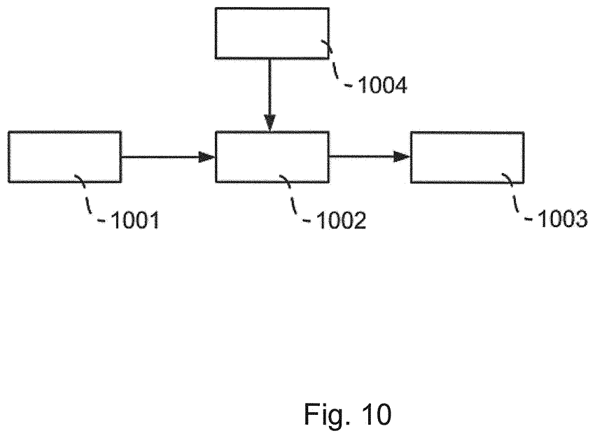

FIG. 10 shows a flowchart showing exemplarily how image processing is done at first user side, in particular by first terminal. Real time video 1001 is captured. Said captured real time video 1001 respectively said process image data or process video data is modified due to image/video processing 1002 (most preferably done at first user side but any other options such as doing computation in cloud, video-conference server or at remote users are possible). Image/video processing 1002 respectively modifying of process image data or process video data is done with recorded data 1004. Data preferably representing at least one eye of the first user is combined with said process image data or process video data. As output 1003 a combined overlaid image/video results.

Thus, overlaying computations shown in FIG. 10 can be transferred to any computation location and system and device, but most likely this computations are done at the user side and device/terminal is more likely computer (desktop, PC, laptop) or smart phone or tablet.

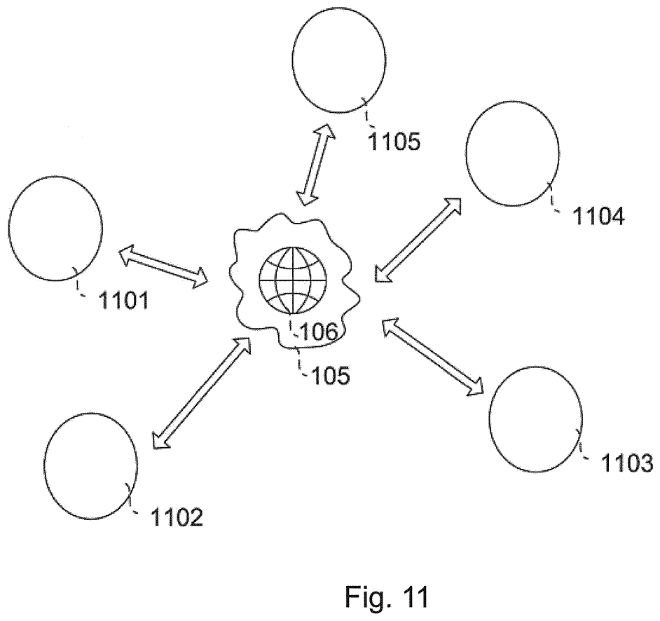

FIG. 11 shows that multiple users with or without a HMD can join an inventive video conference session, wherein at least one of these users uses respectively wears a HMD. Reference number 1101 indicates a first user (corresponding to first user 101 in FIGS. 1, 2 and 3), reference number 1102 indicates a second user, reference number 1103 indicates a second user, reference number 1104 indicates a second user and reference number 1105 indicates a nth user. Thus, the video conference communication preferably occurs between at least two participants and is highly preferably facilitated by at least one transfer medium for video-conference 105, in particular the Internet 106, integrated services digital network or a direct communication link.

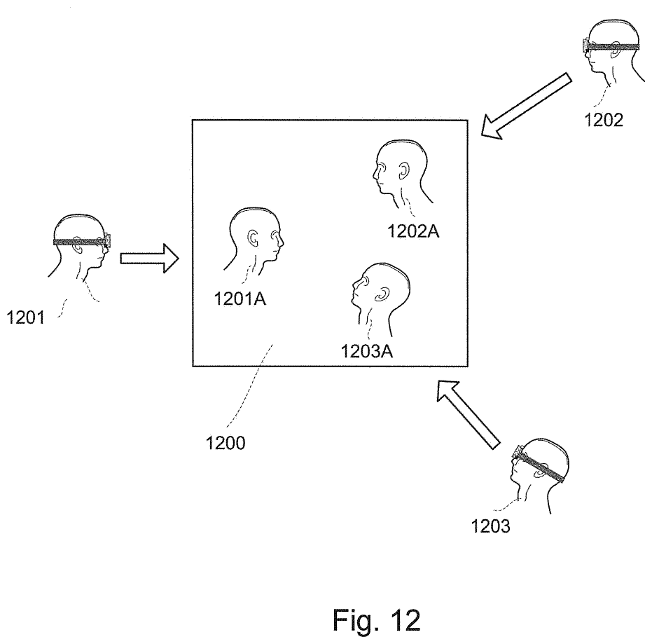

FIG. 12 shows a virtual environment 1200 respectively a virtual meeting room in exemplary case. It is also conceivable that virtual environment 1200 is a virtual spaces in particular for role playing games etc. First user 1201 has a HMD, VR glass in exemplary case. Second user 1202 also has a HMD, VR glass in exemplary case. N^{th} user 1203 also has a HMD, in particular VR glass in exemplary case. As could be seen from virtual environment 1200 all persons meeting in said virtual environment are shown without HMD 1201A, 1202A and 1203A, due to the present invention

Thus, the present invention refers to a system and a method, wherein the method preferably serves for modifying video data during a video conference session and comprises at least the steps: Providing a first terminal 100A, comprising a first camera unit 103X for capturing of at least visual input and a first head-mounted display 102; Providing a second terminal 100B at least for outputting visual input, Providing a server means 105, wherein said first terminal 100A and said second terminal 100B are connected via the server means 105 for data exchange, Providing or capturing first basic image data or first basic video data of a head of a first person 101 with the first camera unit 103X, capturing first process image data or first process video data of the head of said first person 101 with the first camera unit while said first person 101 wears the head-mounted display 102, determining first process data sections of the first process image data or first process video data representing the visual appearance of the first head-mounted display 102, generating a first set of modified image data or modified video data by replacing the first process data sections of the first process image data or first process video data by first basic data sections, wherein the first basic data sections are part of the first basic image data or first basic video data and are representing parts of the face of said person, in particularly the eyes of said first person 101.

Outputting the first modified image data or first modified video data, in particular representing a complete face of said first person 101, via the second terminal 100B.

Therefore, the inventive method, first records or takes pictures of user face without VR/AR glasses. Any technique such as light depth photography or any other 3D or immersive video/photo technique can be used during this process. After user face area near the eyes is modelled, it is preferably stored on device respectively terminal. When user starts to use VR/AR glass in either video conferencing or video calls, computer easily detects the edges of VR/AR glass (or any other method such as identifiers etc.) and combines the video with VR/AR glass to normal video, result is other user see normal face without VR/AR glasses. Additional feature will be eye tracking inside VR/AR glass can also position eyes correctly.

Reference numbers

| | |
|---|---|
| 100A | first user terminal |
| 100B | second user terminal |
| 100C | further user terminal |
| 101 | first person/first user |
| 101A | Front view of user head |
| (first user) | |
| 101B | Side view (profile) of user |
| | head (first user) |
| 102 | first HMD |
| 102A | Front view of HMD device |
| | (VR glass in exemplary |
| | case) |
| 102B | Side view of HMD device |
| | (VR glass in exemplary |
| | case) |
| 103X | first camera unit for video- |
| | conference at first user |
| | (positioned externally in |
| | exemplary case but any |
| | other option is possible) |
| 103Y | Camera for video- |
| | conference at second user |
| | (positioned externally in |
| | exemplary case but any |
| | other option is possible) |
| 103Z | Camera for video- |
| | conference at third user |
| | (positioned externally in |
| | exemplary case but any |
| | other option is possible) |
| 104 | Both user send video-audio |
| | information |
| 105 | Any transfer medium for |
| | video-conference |
| 106 | Transfer medium is internet |
| | in exemplary case |
| A | Second user in video- |
| | conference who uses |
| | screen display |
| 109 | Screen |
| 110 | Transferred video of first |
| | user wearing a HMD |
| 111 | Second user |
| B | Third user in video- |
| | conference who again uses |
| | VR glasses |
| 112 | HMD of further user |
| 112A | Right screen of VR glass |
| 112B | Left screen of VR glass |
| 113A | Transferred video of first |
| | user without any alteration |
| | to right screen of glass |
| 113B | Transferred video of first |
| | user without any alteration |
| | to left screen of glass |
| 114 | Further user |
| 115 | Further head-mounted |
| | display |
| 201 | Recorded head data of first |
| | user for facial motion |
| | capture (with any method |
| | either vector, raster, image |
| | and/or video) |
| 309 | Transferred to computing |
| | system (not shown) for |
| | combine (overlay |
| | superimpose) real time |
| | video with recorded data |
| 202 | Transferred full face view of |
| | first user even he or she |
| | uses HMD |
| 203A | Transferred full face view of |
| | first user even he or she |
| | uses HMD for right display |
| | of VR glass |
| 203B | Transferred full face view of |
| | first user even he or she |
| | uses HMD for left display of |
| | VR glass |
| 301 | User head data is either |
| | taken with learning cycle or |
| | recorded video or similar |
| 302 | Rotating and getting 360° or |
| | similar wide angle data |
| 303 | The size of HMD is detected |
| | and making suitable crop |
| 304 | Suitable crop |
| 305 | Cropped data |
| 307 | Data transferred from crop |
| | by getting suitable HMD |
| | size |
| 308 | Cropped data transfer |
| 310 | Recording device (simple |
| | camera or more complex |
| | devices such as immersive |
| | or light depth camera with |
| | scanning laser support) |
| 401 | Cropped immersive data is |
| | transferred |
| 402 | Overlaying is done |
| 501 | Standalone VR glass or VR |
| | glass with own screen |
| 502 | Kind of AR Glass or mixed |
| | reality glass with one eye |
| | coverage |
| 503 | Kind of AR Glass or mixed |
| | reality glass with one both |
| | eye coverage |
| 601 | Marker-less detection or |
| | electronic detection for |
| | motion capture and size |
| | detection |
| 602 | Dot markers |
| 603 | QR markers |
| 701 | Eye tracker of any kind |
| | (most probably near eye |
| | PCCR tracker) |
| 702 | Detector for face |
| | movements (either |
| | capacitive or optical) |
| 801 | Dot markers |
| 901 | Start |
| 902 | Is invention (disclosed |
| | system) activated |
| 902N/Y | No/Yes |
| 903 | Do nothing |
| 904 | Is HMD detected? |
| 904N/Y | No/Yes |
| 905 | Do nothing |
| 906 | Overlay real time video with |
| | recorded data |
| 907 | Recorded data |
| 908 | End |
| 1001 | Real time video |
| 1002 | Image/video processing |
| | (most preferably done at |
| | first user side but any other |
| | options such as doing |
| | computation in cloud, video- |
| | conference server or at |
| | remote users are possible) |
| 1003 | Output combined overlaid |
| | image |
| 1004 | Recorded data |
| 1200 | Virtual environment, virtual |
| | meeting room in exemplary |
| | case, but also virtual spaces |
| | and/or role playing games |
| | etc. are possible |
| 1201 | First user with HMD, VR |
| | glass in exemplary case |
| 1201A | First user seen in virtual |
| | environment |
| 1202 | Second user with HMD, VR |
| | glass in exemplary case |
| 1202A | Second user seen in virtual |
| | environment |
| 1203 | Nth user with HMD, VR |
| | glass in exemplary case |
| 1203A | Nth user seen in virtual |
| | environment |

1. Method for modifying video data during a video conference session,
at least comprising the steps:
Providing a first terminal,
comprising a first camera unit for capturing of at least visual input
and
a first head-mounted display;
Providing a second terminal at least for outputting visual input,
Providing a server means,
wherein said first terminal and said second terminal are connected via the server means for data exchange,
Providing or capturing first basic image data or first basic video data of a head of a first person with the first camera unit,
Capturing first process image data or first process video data of the head of said first person with the first camera unit while said first person wears the head-mounted display,
Determining first process data sections of the first process image data or first process video data representing the visual appearance of the first head-mounted display,
Generating a first set of modified image data or modified video data by replacing the first process data sections of the first process image data or first process video data by first basic data sections,
wherein the first basic data sections are part of the first basic image data or first basic video data and are representing parts of the face of said person, in particular the eyes of said first person.

2. Method according to claim 1,
characterized in that
the second terminal comprises
a second camera unit
and
a second head-mounted display,
and by steps:
Providing or capturing second basic image data or second basic video data of a head of a second person with the second camera unit,
Capturing second process image data or second process video data of the head of said second person with the second camera unit while said second person wears the second head-mounted display,
Determining second process data sections of the second process image data or second process video data representing the visual appearance of the second head-mounted display,
Forming a second set of modified image data or modified video data by replacing the second process data sections of the second process image data or second process video data by second basic data sections,
wherein the second basic data sections are part of the second basic image data or second basic video data and are representing parts of the face of said second person, in particularly the eyes of said second person,
Outputting the second modified image data or second modified video data via the first terminal.

3. Method according to claim 1,
characterized in that
the first modified image data or first modified video data and/or the second modified image data or second modified video data is/are outputted via at least one further terminal connected to the server means.

4. Method according to claim 1,
characterized in that
a further terminal comprises a further camera unit and a further head-mounted display,
and by steps:
Providing or capturing further basic image data or further basic video data of a head of a further person with the further camera unit,
Capturing further process image data or further process video data of the head of said further person with the further camera unit while said further person wears the further head-mounted display,
Determining further process data sections of the further process image data or further process video data representing the visual appearance of the further head-mounted display,
Forming a further set of modified image data or modified video data by replacing the further process data sections of the further process image data or further process video data by further basic data sections,
wherein the further basic data sections are part of the further basic image data or further basic video data and are representing parts of the face of said further person, in particular the eyes of said further person,
Outputting the further modified image data or further modified video data via the first terminal and/or via the second terminal, in particular at the same time.

5. Method according to claim 1,
characterized in that
first, second and/or further basic video data or first, second and/or further basic image data are stored in a memory of the respective terminal and/or on the server means,
wherein first, second and/or further basic video data or first, second and/or further basic image data are captured once and processed in case first, second and/or further modified video data or first, second and/or further modified image data is required
or
wherein first, second and/or further basic video data or first, second and/or further basic image data are captured each time said first, second and/or third person joins a video conference and the first, second and/or further basic video data or first, second and/or further basic image data is updated or replaced and processed in case first, second and/or further modified video data or first, second and/or further modified image data is required.

6. Method according to claim 1,
characterized in that
at least one terminal and preferably the majority of terminals or all terminals are comprising means for capturing and/or outputting audio data, wherein said captured audio data captured by one terminal is at least routed to one or multiple further terminals.

7. Method according to claim 1,
characterized in that
the position of the first head-mounted display with respect to the face of the first person is determined by means of object recognition,
the shape of the first head-mounted display is determined by object recognition and/or identification data is visually or electronically provided.

8. Method according to claim 1,
characterized in that
face movement data representing movements of skin portions of the face of the first person is generated, wherein the movements of the skin portions are captured by said first camera unit.

9. Method according to claim 1,
characterized in that
eye movement data representing movements of at least one eye of the first person is generated, wherein the movements of the eye are captured by an eye tracking means.

10. Method according to claim 8,
characterized in that
first basic data sections are modified in dependency
of said captured face movement data of the face of the first person, and/or
of said captured eye movement data of at least one eye of the first person.

11. Method according to claim 10,
characterized in that
eye data representing shapes of the eyes of the first person is identified as part of the first basic data sections,
wherein the eye data is modified in dependency of said captured eye movement data,
and/or
skin data representing the skin portions of the face of the first person is modified above and/or below the eyes in the first basic data section is identified,
wherein the skin data in dependency of said captured face movement data.

12. Method according to claim 10,
characterized in that
eye tracking means is preferably a near eye PCCR tracker,
wherein said eye tracking means is arranged on or inside the first head-mounted display.

13. Method according to claim 1,
characterized by
receiving information relating to the pose of the head of the first person;
orienting a virtual model of the head and facial gaze of the head according to the pose of the object;
projecting visible pixels from a portion of the videoconference communication onto the virtual model;
creating synthesized eyes of the head that produces a facial gaze at a desired point in space;
orienting the virtual model according to the produced facial gaze; and
projecting the virtual model onto a corresponding portion of the videoconference communication,
wherein at least one part of the first set of modified image data or modified video data is replaced by said virtual model.

14. Computer program product for executing a method according to claim 1.

15. System for video conference sessions,
at least comprising:
A first terminal,
comprising a first camera unit for capturing of at least visual input and a first head-mounted display,
a second terminal at least for outputting visual input,
a server means,
wherein said first terminal and said second terminal are connected via the server means for data exchange,
wherein first basic image data or first basic video data of a head of a first person is provided or captured with the first camera unit,
wherein first process image data or first process video data of the head of said first person is captured with the first camera unit while said first person wears the head-mounted display,
wherein first process data sections of the first process image data or first process video data representing the visual appearance of the first head-mounted display is determined,
wherein a first set of modified image data or modified video data is formed by replacing the first process data sections of the first process image data or first process video data by first basic data sections,
wherein the first basic data sections are part of the first basic image data or first basic video data and are representing parts of the face of said person, in particularly the eyes of said person,
wherein the first modified image data or first modified video data, in particular representing a complete face of said person, are outputted via the second terminal.
